(19) United States
(12) Patent Application Publication
(10) Pub. No.: US 2025/0308405 A1
(43) Pub. Date: Oct. 2, 2025

(54) MATH ENGINE(S) FOR ENHANCED MATH ASSIGNMENTS WITHIN EDUCATIONAL ENVIRONMENTS

(71) Applicant: Microsoft Technology Licensing, LLC, Redmond, WA (US)

(72) Inventors: Mina SPASIC, Belgrade (RS); Tomislav RADIC, Belgrade (RS); Igor BOJKOVIC, Belgrade (RS); Aleksandra NOVAKOVIC, Belgrade (RS); Luka STOJANOVIC, Belgrade (RS)

(21) Appl. No.: 18/621,867

(22) Filed: Mar. 29, 2024

(51) Int. Cl. G09B 19/02; G09B 3/06

(52) U.S. Cl. CPC G09B 19/02; G09B 3/06

(57) ABSTRACT

Systems and methods for math engines for providing enhanced math assignments are provided herein. In an example, a system may include instructions that direct a computing system to receive, from a first client device, an indication to start a math problem and provide, by a math engine, the math problem to the first client device. The math problem includes a problem statement and the math engine generates answers based on the problem statement. The answers include a correct answer and one or more distraction answers, each of which corresponds to a respective challenge concept. The math engine also receives an answer for the math problem and determines that the answer corresponds to a respective distraction answer of the one or more distraction answers. Based on this determination, the math engine identifies a challenge concept and generates a second math problem based on the challenge concept for the first client device.

### TECHNICAL FIELD

Aspects of the disclosure are related to the field of computer software applications and services and, in particular, to math engines for providing enhanced math assignments within educational environments.

### BACKGROUND

Learning mathematical concepts can be a formidable challenge for many young students. The abstract nature of mathematics, coupled with the sequential and cumulative nature of its content, often leaves students grappling to connect new ideas with previously learned ones. Understanding mathematical principles requires not only memorization of formulas but also the ability to comprehend and apply them in various contexts. For some students, the lack of a tangible or real-world connection to mathematical concepts makes the learning process more arduous. Additionally, the fear of making mistakes can hinder students' willingness to explore and experiment with mathematical problems, leading to a lack of confidence in their abilities. The pace at which new concepts are introduced can also overwhelm some students, making it challenging for them to keep up with the curriculum. Addressing these challenges requires innovative teaching methods that emphasize practical applications, foster a supportive learning environment, and encourage a growth mindset that embraces learning from mistakes.

Mathematical concepts, however, are conventionally taught to students through a structured and systematic approach that often involves a combination of lectures, textbooks, and problem-solving exercises. In many traditional classroom settings, teachers present mathematical ideas through direct instruction, explaining formulas, theorems, and problem-solving techniques. Students are then expected to practice these concepts through exercises and homework assignments to reinforce their understanding. Textbooks play a crucial role, providing a resource for theory, examples, and practice problems. The emphasis is often on procedural fluency, where students learn step-by-step methods to solve specific types of problems. Classroom assessments, such as quizzes and exams, are commonly used to evaluate students' grasp of mathematical concepts. While this conventional approach has its merits in providing a structured foundation, critics argue that it may sometimes neglect fostering a deeper conceptual understanding and the development of critical thinking skills. As education continues to evolve, there is an increasing recognition of the importance of incorporating more interactive and experiential methods to enhance students' engagement and comprehension of mathematical concepts.

Moreover, conventional techniques for teaching mathematical concepts often employ a one-size-fits-all approach, which may not be tailored to the diverse learning needs of individual students. The standardized nature of the curriculum, coupled with a focus on procedural fluency, can lead to an incomplete or inadequate understanding of mathematical concepts for some learners. Students have varying learning styles, paces, and strengths, but traditional methods may not sufficiently address these differences. The emphasis on memorization and rote application of formulas may hinder the development of a deeper conceptual understanding, critical thinking skills, and the ability to apply mathematical principles to real-world situations. Moreover, the rigid structure of conventional assessments, such as exams, may not accurately reflect a student's true mathematical aptitude.

As such, there is a need for a mathematical (“math”) engine, and its related functions, for enhanced assignments that provide math problems that are tailored to individual students. That is, there is a need for more personalized and adaptive learning approaches when it comes to teaching mathematical concepts, including tailoring mathematical instruction and assignments to individual students to provide a more comprehensive and effective learning experience.

### SUMMARY

Technology disclosed herein includes software applications and services that provide a math engine and related functionality for enhanced assignments within educational scenarios. In particular, an example math engine is provided herein to provide tailored math assignments that cater to an individual student's learning needs and challenges. That is, the math engine generates math problems that are individualized to a given student's current understanding of mathematical concepts. For example, if a student finds a particular concept challenging, the math engine generates math problems focused on that challenge concept. As the student masters the challenge concept, the math engine may increase the complexity of the math problems or may present math problems involving another math concept. In other words, the math engine adapts the math problems to the student's current level of understanding and grasp of math concepts.

To provide individualized math problems, the math engine identifies challenge concepts (e.g., concepts that the student finds challenging). To identify a challenge concept, the math engine may generate distraction answers that contain a wrong solution to a respective math problem. The distraction answers are calculated based on a specific incorrect step performed during the solution process. Since the distraction answers are generated based on a specific incorrect step (or combination of incorrect steps), the student's selection of a given distraction answer indicates where the shortcoming is with the student's grasp of the challenge concept.

Additionally, the math engine provides educators with information on how students are mastering various math concepts both on an individual basis and on a class basis. In an aspect, the math engine tracks how well each student performs on math problems directed to various math concepts and provides a summary to the educator. Such a summary provides the educator with vital information on how material is received by students and provides insight on what concepts should be the focus of future lessons.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for providing a math engine for enhanced assignments, according to an embodiment herein;

FIG. 2 illustrates a brief operational scenario to further highlight an application of the math engine, according to an embodiment provided herein;

FIG. 3 illustrates a system for providing a math engine and related functions, according to an embodiment herein;

FIG. 4 illustrates a process for providing the math engine and its related functions, according to an embodiment herein;

FIGS. 5A-B illustrate an example math problem and related solution, according to an embodiment herein;

FIG. 6 illustrates an example template for generating a math problem via the math engine, according to an embodiment herein;

FIG. 7 illustrates an answer template for generating answers via the math engine, according to an embodiment herein;

FIGS. 8A-B illustrate a freeform math problem and related solution, according to an embodiment herein;

FIG. 9 illustrates a freeform answer template for generating answers to a freeform math problem, according to an embodiment herein;

FIG. 10 illustrates a graphical user interface (GUI) for providing a math engine, according to an embodiment herein;

FIG. 11 provides a GUI for illustrating a submitted assignment view, according to an embodiment herein;

FIG. 12 provides a GUI illustrating concept progress by student within a class, according to an embodiment herein; and

FIG. 13 shows an example client device suitable for providing a math engine and related functions, according to an embodiment herein.

### DETAILED DESCRIPTION

Teaching mathematics to young students is of paramount importance, serving as a cornerstone for the development of crucial cognitive and problem-solving skills that extend well beyond the confines of the classroom. Mathematics is not merely a subject; it is a tool that equips young minds with the ability to analyze, reason, and think logically. Early exposure to mathematical concepts cultivates a mindset of inquiry and exploration, fostering resilience and perseverance in the face of challenges. Moreover, mathematical literacy is increasingly vital in our technologically driven world, where quantitative reasoning is integral to various fields. From basic arithmetic to more advanced problem-solving, math provides a framework for understanding the order and structure inherent in the world. Beyond its practical applications, the study of mathematics instills a sense of precision and discipline, essential qualities for success in any academic or professional pursuit. Thus, teaching math to young students not only imparts valuable skills but also empowers them with a versatile intellectual toolkit that is fundamental to lifelong learning and achievement.

Conventional methods of teaching mathematics, however, frequently fall short in effectively conveying mathematical concepts to students, due to their standardized, one-size-fits-all approach, which often does not cater to diverse learning styles and individual needs. This lack of adaptability can hinder a deep understanding of mathematical principles, as students may not receive the targeted support or challenges necessary for comprehensive learning. One issue present in traditional teaching methods is the reliance on identical assignments for all students within a class. The one-size-fits-all approach assumes that every student learns at the same pace and through the same cognitive pathways, neglecting the diverse learning styles and individual needs present in any classroom. Such uniform assignments may not effectively address the varying levels of readiness, prior knowledge, and unique challenges that students bring to their mathematical learning. While some students may find the assignments too challenging, leading to frustration, others may find them too easy, resulting in a lack of engagement. The absence of differentiation in assignments can hinder the development of a deep and nuanced understanding of mathematical concepts, as students may not receive the targeted support or challenges they require. Embracing more personalized and differentiated approaches in assigning tasks can better cater to the diverse needs of students, fostering a more inclusive and effective learning environment for mastering mathematical concepts.

To address the shortcomings of traditional teaching methods for mathematical concepts, an example math engine, and its related functions, are provided herein. The math engine provides individualized math assignments that cater to a student's learning needs and current understanding of concepts. That is, the math engine may monitor a student's grasp of various mathematical concepts (e.g., order of operations) and tailor a math assignment based on the student's understanding of the concept. For example, if the student struggles with the order of operations concept, then the math engine may generate a math assignment that contains math problems focused on order of operations.

The math engine may also generate distraction answers that contain a wrong solution that is calculated based on a specific incorrect step (or combination of steps) during the solution process to identify a specific issue within the mathematical concept that the student may be struggling with. Following the above example, the distraction answers may include solutions in which a student adds or subtracts before multiplying or divides before addressing exponents. By providing the distraction answers, the math engine can identify what specific issue (e.g., adding/subtracting before multiplying) the student is struggling with and hone math problems to focus on this issue. Thus, instead of providing numerous math problems to concepts that the student understands, the math engine provides math problems that are tailored to the student's weakness, thereby providing the student the ability to practice at the problem concept until it is better understood.

Additionally, the math engine can provide educators with information on how students are grasping various math concepts. That is, the math engine can track how well each student performs on math problems directed to various math concepts and provides a summary to the educator. Such a summary can provide the educator with vital information on how material is received by students and provide insight on what concepts should be the focus of future lessons. Furthermore, in some examples, the math engine leverages content generators, such as large language models (LLMs), for generation of math problems. The math engine includes math problem templates and answer templates that provide basic formats for a problem statement and answers that are used by a content generator to generate a problem set, such as a math assignment. The math problem template and answer template include rules and expression bounds for the math problem, by which the content generator can prepare math problems directed to a desired mathematical concept. Additionally, in some embodiments, the content generator may take into account challenge information (e.g., math concepts that the student struggles with) for a specific student such that the math problem or assignment can be further tailored to that student's needs.

Overall, the math engine, and related functionality, provided herein not only improves the educational environment by providing enhanced math assignments tailored to students' individualized needs, but it also provides educators with vital information required to adapt their teaching approach to the students' pace, knowledge, and specific challenges. The math engine helps build a deeper conceptual understanding of mathematical principles, promotes critical thinking skills, and instills confidence in students as they navigate the intricacies of the subject. By fostering students' knowledge and appreciation for math, the math engine aids students with gaining essential problem-solving skills that are applicable in various real-world scenarios, from managing personal finances to making informed decisions in diverse professional fields. Overall, the individualized teaching approach provided by the math engine and the subsequent acquisition of mathematical skills contribute not only to academic success but also to the development of practical, transferable skills crucial for lifelong learning and success.

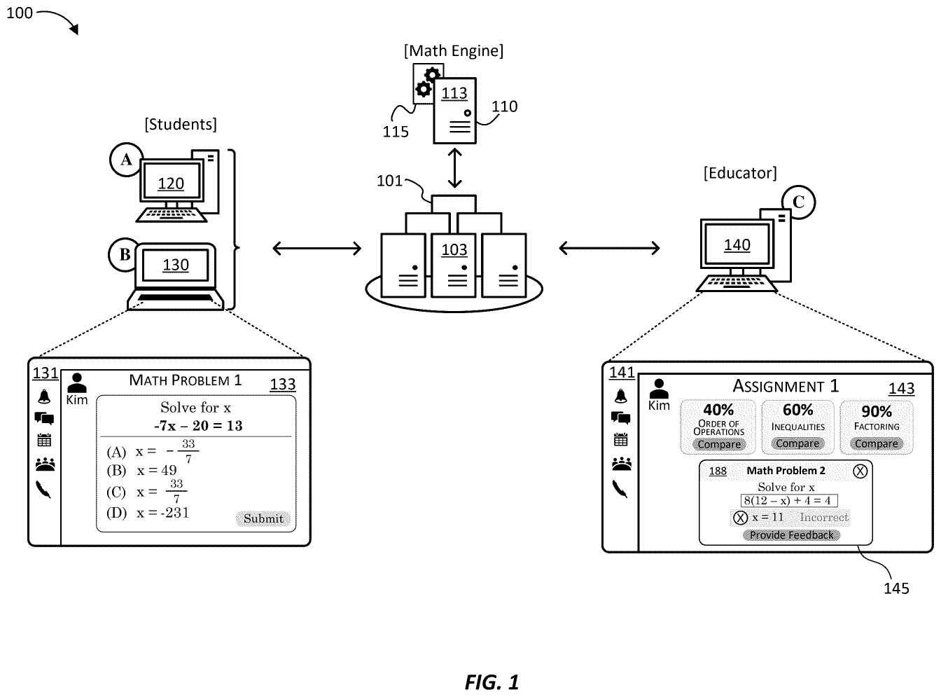

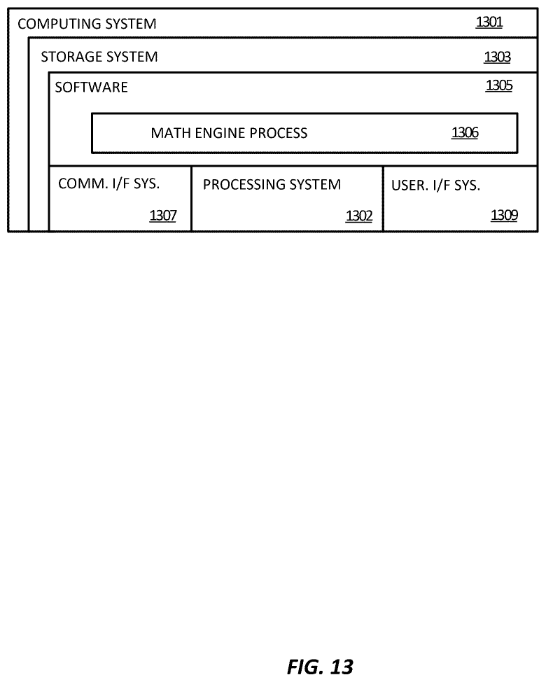

Turning now to FIG. 1, FIG. 1 illustrates an operational environment 100 for providing a math engine for enhanced assignments, according to an embodiment herein. As illustrated, the operational environment 100 includes an application service 101, a math engine 110, and client devices 120, 130 and 140. The application service 101 employs one or more server computers 103 co-located with respect to each other or distributed across one or more data centers. Example servers include web servers, application servers, virtual or physical servers, or any combination or variation thereof, of which computing system 1301 in FIG. 13 is broadly representative.

The client devices 120, 130, and 140 communicate with application service 101 via one or more internets and intranets, the Internet, wired and wireless networks, local area networks (LANs), wide area networks (WANs), or any other type of network or combination thereof. Examples of the client devices 120, 130, and 140 may include personal computers, tablet computers, mobile phones, gaming consoles, wearable devices, Internet of Things (IoT) devices, and any other suitable devices, of which computing system 1301 in FIG. 13 is also broadly representative.

Broadly speaking, the application service 101 provides software application services to end points, such as the client devices 120, 130, and 140, examples of which include productivity software for creating content (e.g., word processing documents, spreadsheets, and presentations), email software, and collaboration software. The client devices 120, 130, and 140 load and execute software applications locally that interface with services and resources provided by the application service 101. The applications may be natively installed and executed applications, web-based applications that execute in the context of a local browser application, mobile applications, streaming applications, or any other suitable type of application. Example services and resources provided by the application service 101 include front-end servers, application servers, content storage services, authorization and authentication services, and the like.

The application service 101 also includes an integration with the math engine 110, which is capable of generating math problems, analyzing answers, and reporting on a student's progress. The math engine 110 may include one or more functions that allow the math engine 110 to generate math problems tailored to a student's needs, problem check a student's answers for a given math problem, and generate a summary of the student's answers and progress based on the student's interactions via the application service 101. For example, the application service 101 may provide an enhanced math assignment application through which the math engine 110 provides one or more of its functions.

To provide these functions, the math engine 110 employs one or more server computers 113 co-located with respect to each other or distributed across one or more data centers, of which computing system 1301 in FIG. 13 is broadly representative. In some embodiments, the math engine 110 hosts a content generator 115 on server computers 113 as well. In other embodiments, the content generator 115 may be hosted separately from the math engine 110, such as by a third party. As will be described in greater detail below, the math engine 110 may provide templates (e.g., math problem and/or answer templates) to the content generator 115 for generation of one or more math problems.

The application service 101 hosts or provides an application, such as a math assignment application, through which users of the client devices 120 and 130, user A and user B, respectively, can practice their math skills. For example, the application service 101 may provide or host an educational application through which assignments are assigned by an educator, such as the user of the client device 140 (user C). Users A and B may be students in the illustrated example. As such, users A and B may perform and complete one or more math assignments provided by the application service 101 via a corresponding math application.

To generate math problems within a given math assignment, the math engine 110 may gather challenge information for a respective student. For example, the math engine 110 may gather challenge information, such as from past assignments, corresponding to math concepts that user B struggles with. As can be appreciated, struggling with a math concept or having a weakness with a math concept relates to a student's ability to understand the various aspects of a given concept and apply the concept within a math problem to arrive at the correct answer.

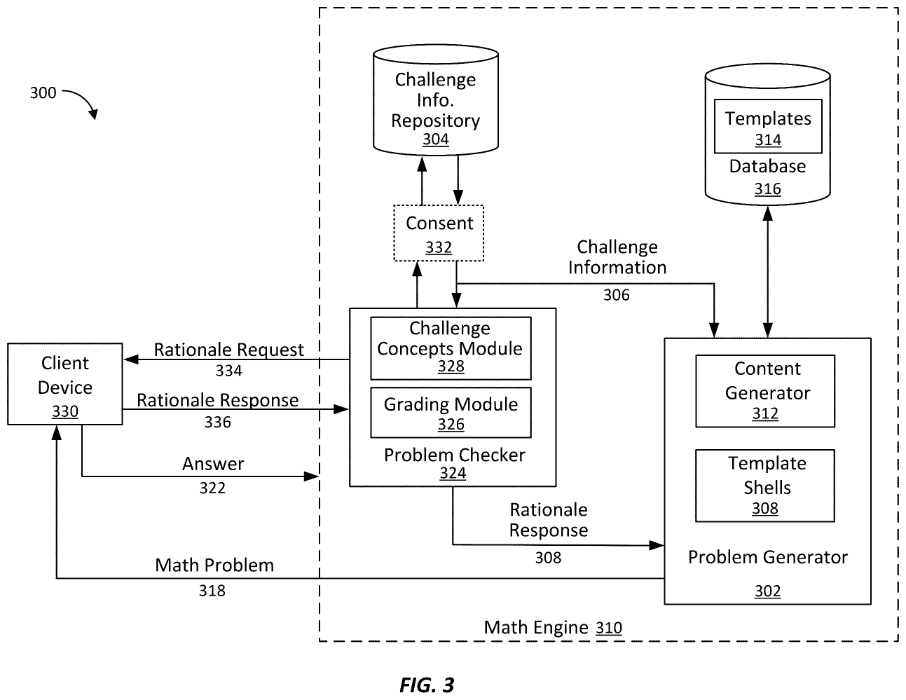

To aid user B with understanding a challenge concept (e.g., a math concept that the student struggles with), the math engine 110 generates one or more math problems directed to the challenge concept. That is, once a challenge concept is identified, the math engine 110 may generate math problems directed at that challenge concept using one or more templates. Generation of math problems and the associated templates are described in greater detail below with respect to FIGS. 3-9. Once generated by the math engine 110, a math problem is provided to user B via a user interface 131 of an application (e.g., math assignment application) executing on the client device 130. As illustrated, the user interface 131 may provide a math problem 133 with which user B can interact with, including providing an answer.

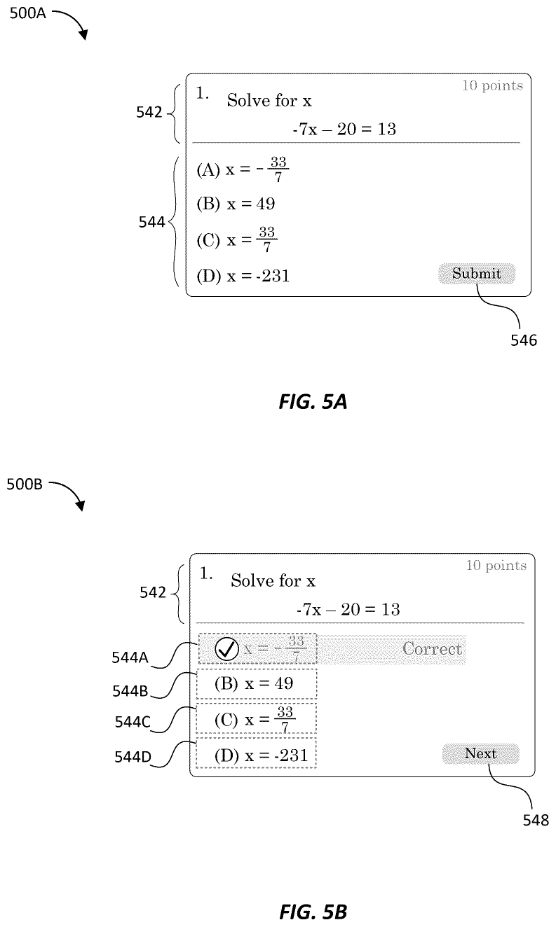

Once user B provides an answer or otherwise interacts with the math problem 133 (e.g., user B could skip math problems that he or she is not comfortable answering), the math engine 110 analyzes the answer and/or interaction. For example, the math engine 110 may problem check the answer against a set of answers generated alongside of the math problem. As noted above, to identify challenge concepts, the math engine 110 generates one or more distraction answers. A distraction answer may be a wrong answer generated by performing one or more solutions steps incorrectly. For example, if the challenge concept is order of operations, then a distraction answer may be one that is generated by performing addition prior to performing multiplication to solve the math problem. By providing various distraction answers, the math engine 110 can readily identify not only a challenge concept, but what feature of the challenge concept a student may be grappling with. The user interface 131, in particular the math problem 133, is described in greater detail below with respect to FIGS. 5A-B and 8A-B.

Once user B provides an answer to the math problem 133, the math engine 110 may generate a report of the interaction. As can be appreciated, the math problem 133 may be worked through or solved as part of a math assignment containing multiple math problems. As such, user B may have provided answers for each of the math problems within the given assignment. Once the assignment is completed and interactions received for each of the math problems (e.g., providing an answer or skipping a problem), the math engine 110 may generate a summary of the assignment. The summary may include a problem checker that grades the overall assignment and provides an analysis of each math concept present within the assignment. For example, the math assignment may include ten (10) math problems focused on the math concept for order of operations, ten (10) math problems focused on the math concept for inequalities, and ten (10) math problems focused on the math concept for factoring. As such, the math engine 110 may provide a summary indicating that user B solved 40% of the order of operations problems correctly, solved 60% of the inequalities problems correctly, and solved 90% of the factoring problems correctly. Based on this summary, the math engine 110 may identify the concept of order of operations as a challenge concept for user B, and in some cases, the concept of inequalities as well. It should be appreciated that as used herein the term “concept” is meant to cover both math concepts (e.g., order of operations) and math topics (e.g., quadratic equation).

The summary may be provided to user C, who may be an educator in this scenario. User C may view the summary via a user interface 141 of an application executing on the client device 140. As illustrated, the user interface 141 may include a summary 143 of the assignment as completed by user B via the user interface 131. As will be described in greater detail below, the summary 143 may include various metrics that indicate user B's progress on math concepts covered in a given assignment. In some cases, the user interface 141 may include a component 145 that provides answers submitted by user B and provides user C an option to provide feedback on the submitted answers.

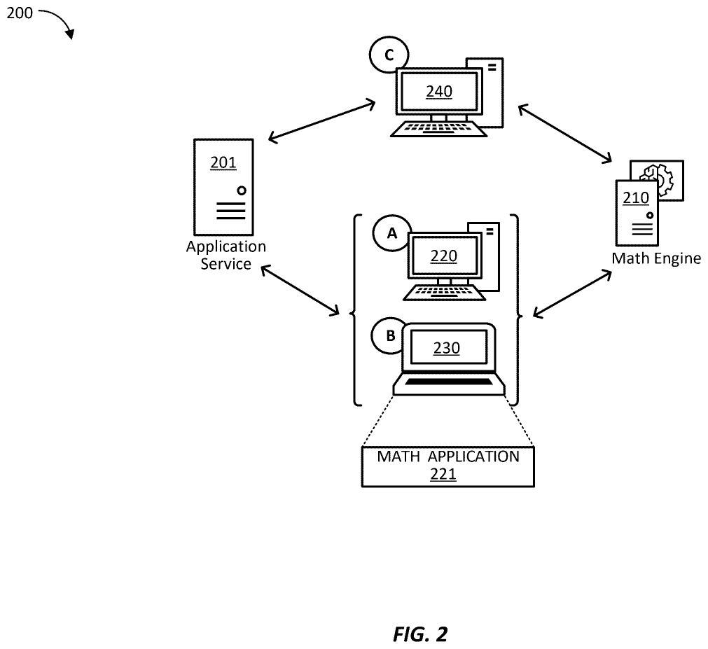

Turning now to FIG. 2, FIG. 2 illustrates a brief operational scenario 200 to further highlight an application of the math engine, according to an embodiment provided herein. As shown, in operational scenario 200, there are two observed users (e.g., students), users A and B, and a reviewing user (e.g., educator), user C. Users A and B may operate the client devices 220 and 230, respectively, which may be the same or similar to the client devices 120 and 130 described above with respect to FIG. 1. Similarly, user C may operate the client device 240, which may be the same or similar to the client device 140.

Following the above example for user B, user B may open an application, such as a math application 221 (e.g., an education-based collaboration application), to begin a math assignment. To open the application, the client device 230 may communicate with an application service 201, which may be the same or similar to the application service 101. The application service 201 may initiate and operate the math application 221 on the client device 230. Once the application is open on the client device 230, user B may begin a math assignment within the math application 221 by, for example, selecting answers or otherwise providing answers to math problems provided by the math application 221.

The math application 221 provides enhanced math assignments as provided by math engine 210. The math engine 210 may be the same or similar to the math engine 110. As such, in some embodiments, upon initiating the math application 221 on the client device 230, software corresponding to the math engine 210 may also be initiated. That is, settings associated with the math application 221 may indicate a certain assignment is handled (e.g., generated and tracked) by the math engine 210. For example, if user C is an educator, user C may have assigned a math assignment to be completed in the math application 221. As part of the assignment, user C may have selected a setting to have the math engine 210 generate the math problems present within the math assignment based on the completing student, here user B, and observe the completion of the assignment. As such, the math engine 210 generates the math problems within the math assignment based on challenge information for user B, such as what math concepts user B finds challenging, and provides the math assignment to user B via the math application 221.

As user B completes the math assignment via the math application 221, the math engine 210 observes user B's interactions with the math problems. For example, the math engine 210 tracks which math problems user B answers correctly and which problems the user B answers incorrectly. Beyond noting what math problems user B answers incorrectly, the math engine 210 observes which of the incorrect answers user B provides. As will be described in greater detail below, when the math engine 210 generates a math problem, the math engine 210 generates distraction answers as incorrect answers. The distraction answers are generated by performing one or more solution steps incorrectly, to identify a challenge concept that a user may have with respect to a math concept. As such, the math engine 210 observes which distraction answers are selected or otherwise entered and uses the distraction answers to identify a pattern in incorrect answers. The pattern may indicate a challenge concept or misunderstanding that a student may hold with respect to a math concept (e.g., subtracting before multiplying).

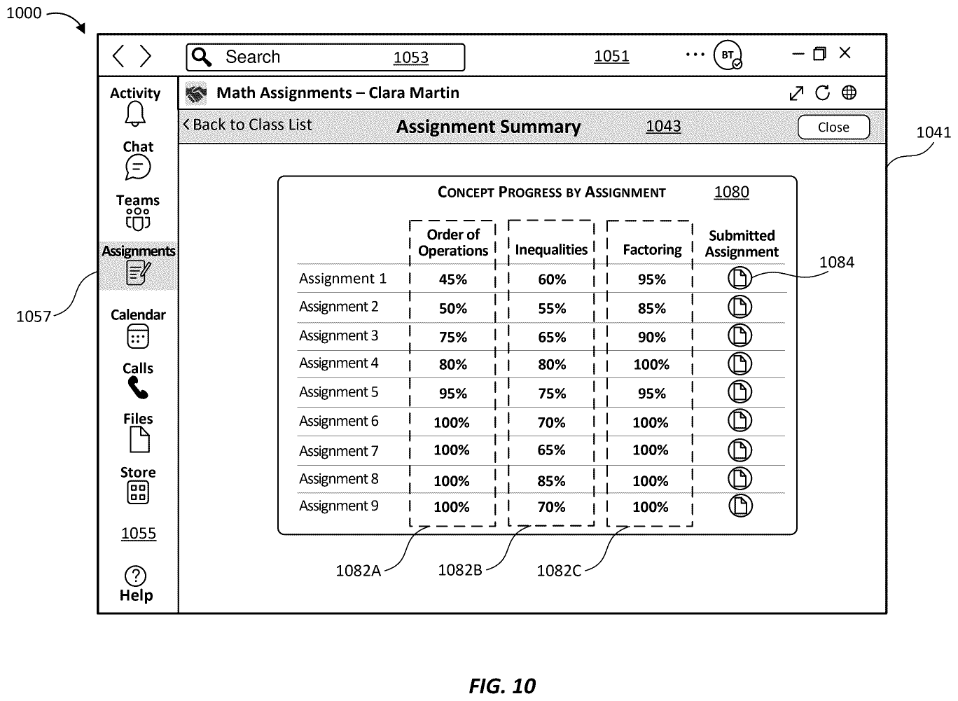

After a student completes and submits the math assignment via the math application 221, the math engine 210 generates a report or summary of the math assignment. The report may indicate any challenge concepts that the student may have on a respective math concept. The report may also provide various metrics, such as a number of correct responses vs. incorrect responses for the math assignment. Additionally, the math engine 210 may generate a summary that provides metrics on user B's progress with respect to a respective math concept. For example, if order of operations is a challenge concept for user B, then the math engine 210 generates a summary showing user's B progression with respect to this concept over time. Reports and summaries generated by the math engine 210 are discussed in greater detail below, in particular, with respect to FIGS. 10-12.

Turning now to FIG. 3, a system 300 for providing a math engine 310 is illustrated, according to an embodiment herein. The system 300 includes the math engine 310 and a client device 330, which may be the same or similar to the math engine 110 and the client device 130, respectively. The math engine 310 may provide an enhanced math assignment for a user of the client device 330. For ease of discussion, the user is described as a student within an educational environment; however, it should be appreciated that other scenarios are also contemplated.

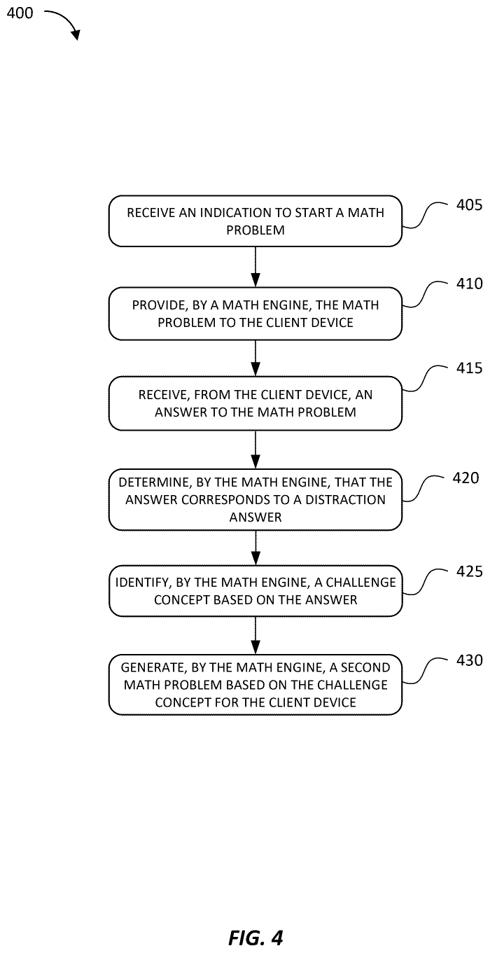

For ease of explanation, FIG. 3 is described in combination with FIG. 4. FIG. 4 illustrates a process 400 for providing the math engine 310 and its related functions, according to an embodiment herein. The process 400 may also be noted as the math engine process 400 herein. Although the process 400 is described with respect to components and elements of FIG. 3, it should be appreciated the one or more steps of the process 400 may be executed or applied to components or elements of any other Figure provided herein.

The process 400 begins when a student associated with the client device 330 starts a math assignment. For example, the client device 330 provides an indication, such as in response to the student opening a math assignment, to begin the math assignment. The math engine 310 receives the indication to start the math assignment, or in some cases, to start a particular math problem (405). Responsive to receiving the indication to start the math problem, the math engine 310 provides the respective math problem to the client device 330 (410). The math problem may be generated by the math engine 310 responsive to receiving the indication to start the math assignment or problem, while in other cases the math engine 310 generates math problems prior to receiving the indication from the client device 330. In such cases, the math engine 310 provides the math problems to the client device 330 responsive to the indication to start and/or upon identification of a respective student (e.g., the student logins in).

The math engine 310 includes a problem generator 302 for generating math problems. In some embodiments, the math engine 310 generates the math problems based on the client device 330. For example, the math engine 310 generates one or more math problems based on challenge information 306 associated with the client device 330. The challenge information 306 may be stored in a challenge information repository or database 304. The challenge information repository 304 may store challenge information 306 associated with the client device 330. Challenge information 306 associated with the client device 330 may include information associated with a user of the client device 330 that can be used to generate the math problems. For example, challenge information 306 may include the user's age, grade, class information, curriculum, and/or current lesson plan. As can be appreciated, using information such as the user's grade or class information (e.g., algebra vs. calculus class), the math problems generated by the problem generator 302 can be designed to be appropriate for the student and the associated class.

The challenge information 306 may also include challenge concepts associated with the user. As noted above, a challenge concept is a concept that the user may struggle with or have a challenge as to the underlying principles of the concept. As will be described in greater detail below, the math engine 310 may identify a challenge concept for a user by observing or recording distraction answers submitted by the client device 330. In a brief example, if the user selects only one or two distraction answers corresponding to a concept, these selections may be identified as merely mistakes on part of the user. However, if the user consistently or more than a threshold number of times (e.g., more than 25%, 40%, or 50% of the time) selects a distraction answers corresponding to a principle of the concept, then the math engine 310 may identify this concept as a challenge concept associated with the client device 330.

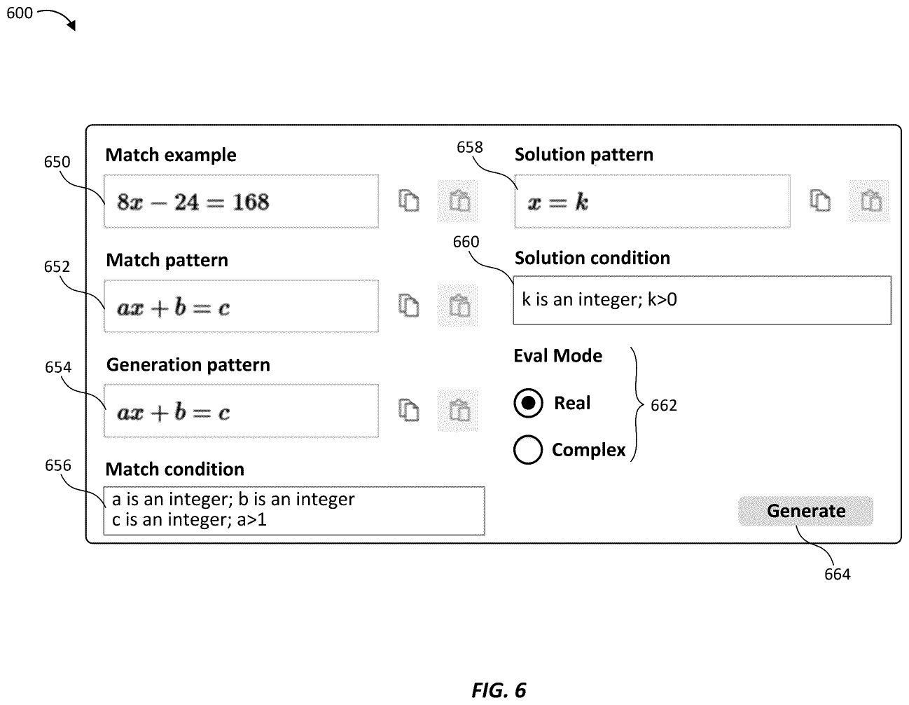

To generate the math problems, the problem generator 302 includes a content generator 312 and one or more template shells 308. The template shells 308 may provide a guide through which an educator may generate a math template. Template shells 308 are described in greater detail below with respect to FIGS. 6, 7, and 9. Alternatively or in addition to educators generating math templates using the template shells 308, the math engine 310 may include a number of math templates 314. The math templates 314 may include math problem templates for generating the problem statement for a math problem and answer templates for generating one or more answers for the math problem. In some cases, a single template may be used for generating both the math problem statement and the answers. As will be described in greater detail below with respect to FIGS. 5A-9, the answer template may include a guide for generating one or more distraction answers, and in some cases, also the correct answer. The math templates 314 may be stored in a template database 316. Although the template database 316 is illustrated as part of the math engine 310, the template database 316 may be separate from the math engine 310, for example, hosted by a third party.

A math problem may be generated based on a variety of information, such as on a category or topic, and in some cases based on challenge information 306 associated with a particular student. That is, in some embodiments to generate a math problem, the problem generator 302 receives challenge information 306 associated with the client device 330 and selects one or more templates 314 based on the challenge information 306. For example, if the challenge information 306 indicates that the user is in an algebra class then templates 314 corresponding to algebra for the user's grade level are selected. In some cases, the selection of the templates 314 is more refined. For example, the challenge information 306 may also indicate that the user struggles with the challenge concept of order of operations. As such, the problem generator 302 selects templates 314 for generating problems directed to practicing order of operations within the context of algebra at the user's grade level.

Once the templates 314 are selected based on the challenge information 306, then the templates 314 may be provided to a content generator 312 for generating the math problem. The content generator 312 may be a text-to-text or text-to-image generative model, such as a large language model (LLM). Examples include generative pre-trained transformer models or multimodal generative models. The content generator 312 uses the templates 314 to generate one or more math problems directed to the client device 330. In some cases, one or more elements of the challenge information 306 may be used to generate the math problems.

Once generated, a math problem 318 is provided to the client device 330 (410). The math problem 318 may be provided via a user interface, such as the user interface 131, to the user of the client device 330. The user may work through the math problem 318 and provide an answer 322 to the math engine 310. As will be described in greater detail below, depending on the format of the math problem 318 the user may select an answer, type or write in an answer, or even provide an image of the answer. Once submitted, the math engine 310 receives the answer 322 from the client device 330 (415). In particular, the answer 322 may be received by a problem checker 324 of the math engine 310. The problem checker 324 may compare the answer 322 to the answers generated by the problem generator 302, including the distraction answers.

The problem checker 324 includes a grading module 326 and a challenge concepts module 328. The problem checker 324 determines if the answer 322 corresponds to a distraction answer or incorrect answer (420). The grading module 326 grades the answer 322 within the context of the math problem itself (e.g., whether the answer 322 is an incorrect answer or an incorrect answer) and in the context of the math assignment as a whole (e.g., does the answer 322 indicate a challenge concept). In other words, the grading module 326 may determine if the answer 322 is a correct answer or an incorrect answer, and whether the answer 322 indicates that the student struggles with a respective concept. Once a math assignment is completed, the grading module 326 generates a score or grade for the math assignment.

The challenge concepts module 328 identifies one or more challenge concepts present within the user's answer 322 (425). As noted above, selection of a given distraction answer provides insight into what principle of a math concept the user is struggling with. The challenge concept module 328 tracks the distraction answers that are selected over a range of math problems and determines a challenge concept for the client device 330 based on the answers. As noted above, to identify a challenge concept or challenge concept, the challenge concept module 328 may determine whether a threshold number of mistakes or incorrect answers were selected. For example, if the user selects one or two distraction answers corresponding to a respective concept, but correctly answers the remaining math problems directed to the same concept, then the challenge concept module 328 may determine the incorrect answers to be merely mistakes. However, if the user selects or otherwise responds with multiple distraction answers corresponding to a respective concept, then the challenge concept module 328 may determine that the incorrect answers are all related to the same challenge concept or misunderstanding of the underlying concept. This underlying concept is the challenge concept for the client device 330. Upon identification of a challenge concept, the problem checker 324 may transmit and/or store the challenge concept within the challenge information repository 304. In some cases, consent 332 may be requested from the client device 330 prior to storing the challenge concept or any of the other challenge information 306. For example, when the user opens the math application or downloads software corresponding to the math application, the user may be prompted to provide consent 332 for the math engine 310 to observe and store challenge information relating to the client device 330. By storing the challenge concept identified by the answer 322, the math engine 310 can generate a second math problem based on the challenge concept identified by the challenge concept module 328 (430). In this manner, the math engine 310 focuses the math assignment to the user of the client device 330, tailoring the math problems to the needs of that particular student.

In some cases, the problem generator 302 may refine each round of math problems based on the feedback from the problem checker 324. That is, if the problem checker 324 identifies a challenge concept after a first round of math problems, and the student continues to struggle with the same challenge concept after the second round of math problems, then the problem generator 302 may generate incrementally easier math problems with each subsequent round. In this manner, the math problems generated by the problem generator 302 are refined to be simpler or easier for the student until the student exhibits an understanding of the basic principles of the math concept. Once the answers 322 provided by the client device 330 begin to indicate that the student has a grasp of the concept (e.g., the student begins answering correctly above a threshold number of questions), then the problem generator 302 may generate incrementally more complex and harder math problems.

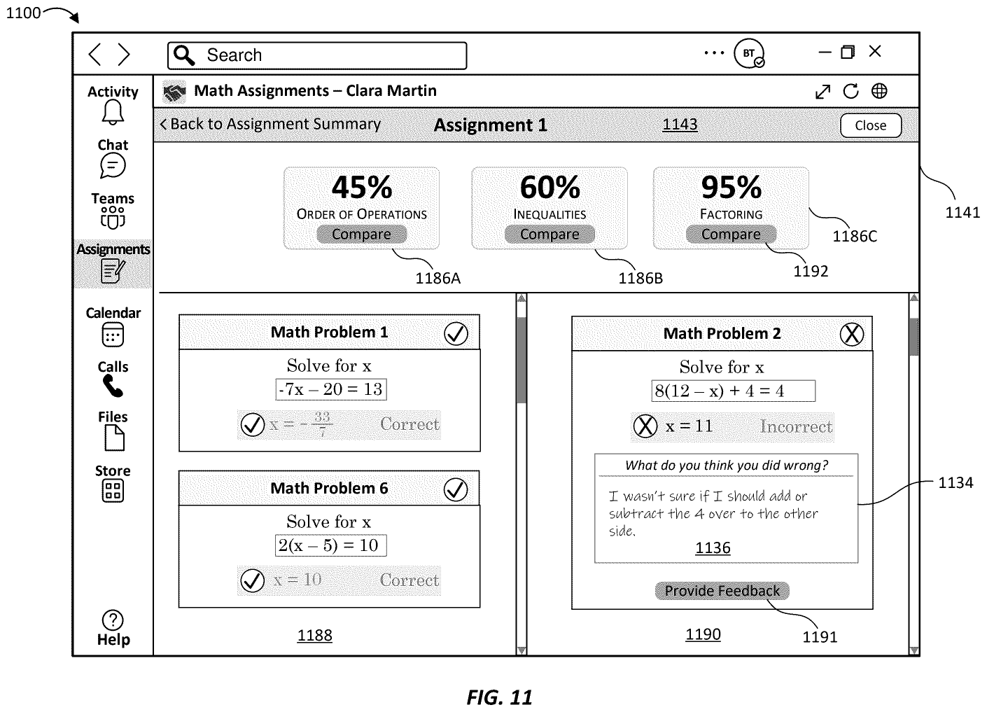

In some cases, after the math engine 310 receives an incorrect answer, the math engine 310 may prompt the user with a rationale request 334. For example, the math engine 310 may ask the user why the incorrect answer was selected or request a step-by-step solution from the user. Responsive to the rationale request 334, the student may provide a rationale response via the client device 330. The rationale response 336 may be provided to the problem generator 302 for generation of future math problems and/or may be provided to the challenge information repository 304. In still other examples, the rationale response 336 may be provided as part of the report or summary generated by the math engine 310 that is provided to an educator or reviewer. Such an example is described in greater detail below with respect to FIG. 11.

Turning now to FIGS. 5A and 5B, an example math problem is provided, according to an embodiment herein. FIG. 5A provides a math problem 500A prior to solution and FIG. 5B provides math problem solution 500B after an answer is selected. As shown, the math problem 500A includes a problem statement 542 and multiple answers 544. The problem 500A is in a multiple-choice format in which it includes multiple answers 544. As shown in FIG. 5B, the multiple answers 544 include one correct answer 544A and multiple distraction answers 544B-D. Once a student selects a desired answer 544, the student selects a submit option 546 and may be provided with the math problem solution 500B. As illustrated, the math problem solution 500B indicates the correct answer 544A and provides an option 548 to continue to a next math problem.

The math problem 500A may be generated by a content generator of the math engine, such as the content generator 312 using one or more templates 314. Referring now to FIG. 6, an example template 600 is provided for generating a math problem, according to an embodiment herein. Specifically, the math template 600 may be used to generate the math problem 500A. The template 600 may be provided by the math engine 110 or may be generated by an educator. In the scenario that an educator is generating the template 600, then inputs to one or more of the elements 650-662 may be provided by the educator.

As shown, the template 600 provides one or more elements 650-662 into which information for a math problem may be provided. For example, a math pattern element 652 provides a generic equation for the math problem. The math example element 650 provides an example equation containing values based on the generic equation provided in the math pattern element 652. The generation pattern element 654 provides a pattern for problem statements to follow as multiple math problems are generated. The template 600 also includes match condition elements 656 that specify conditions for each of the variables present in the generic equation provided in the match pattern element 652. Here, the match condition elements 656 specify that values for a, b, and c are integers and that a is greater than 1.

The template 600 also includes a solution pattern element 658 that specifies the correct answer pattern. The solution condition element 660 specifies conditions for the solution provided in the solution pattern element 658. Here, x=k and the solution condition element 660 specifies that k is an integer and greater than zero. The template 600 also provides an evaluation mode element 662 which specifies an evaluation mode for determining the nature of the solution to the math problem. Here, the evaluation mode element 662 provides the option between real solutions and complex solutions.

Once the elements 650-662 are provided, then a generating user can select generate option 664 to generate one or more math problems based on the template 600. In some cases, the template 600 does not include the generate option 664 and instead the template 600 is part of the templates 314 stored within the template database 316.

The template 600 may be a math problem template since it provides the information necessary to generate a problem statement for the math problem. In some cases, the template 600 includes an answer template but in other examples, a separate answer template may be used. In the illustrated example, the template 600 is a math problem template that includes a template for generating the problem statement and a corresponding correct answer. Following this scenario, a corresponding answer template is used to generate the one or more distraction answers.

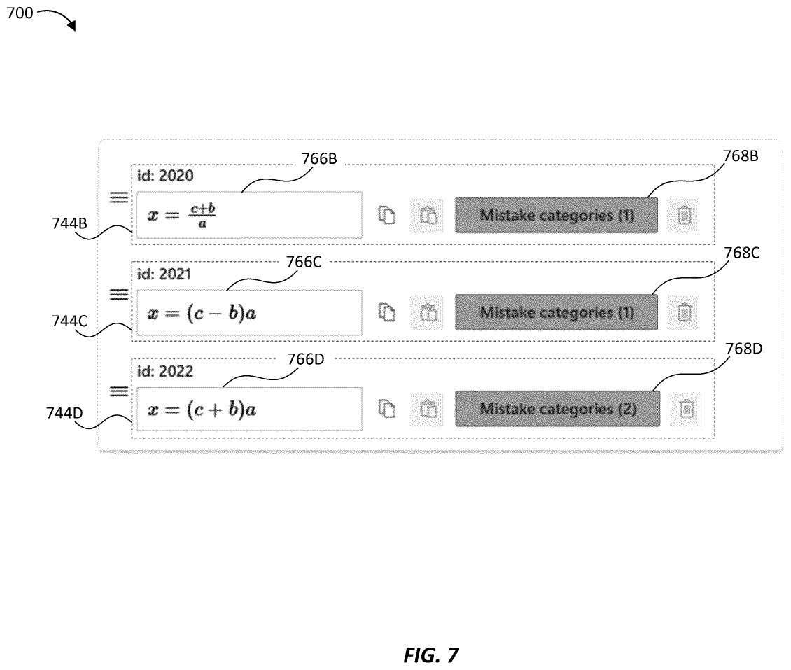

Referring now to FIG. 7, an answer template 700 is provided, according to an example herein. The answer template 700 provides the template for generating distraction answers 744B-D. The distraction answers 744B-D may correspond to the distraction answers 544B-D. Since the template 600, or math problem template in this scenario, provides a solution pattern and solution conditions, the correct answer 544A is generated along with the problem statement 542. Thus, the answer template 700 is used to generate the distraction answers 744B-D, corresponding to distraction answers 544B-D.

As shown, each of the distraction answers 744B-D corresponds to a different underlying solution equation 766B-D, respectively. Each of the solution equations 766B-D corresponds to an incorrect solution to the generic equation provided in the template 600 in which one or more solution steps are incorrectly performed. For example, for the distraction answer 744B, the solution equation 766B provides an incorrect solution in which the variable ‘a’ is divided into (c+b) as a positive value instead of a negative value. In the correct solution, ‘a’ is divided into (c+b) as a negative value based on the generic equation of template 600. The solution equation 766B also includes a second incorrect step of adding the variable ‘b’ to ‘c’ instead of subtracting it. Solution equations 766C and 766D provide similar incorrect solutions to the generic equation provided by the template 600.

As can be appreciated, because each of the solution equations 766B-D provide an incorrect solution to the generic equation used to generate math problems, a student's selection of a given distraction answer 744B-D provides information on what mistake(s) the student made while solving the math problem. In some cases, each of the solution equations 766B-D may be categorized into a respective mistake category. Here, the solution equations 766B-D correspond to mistake categories 768B-D, respectively. A mistake category may correspond to a mathematical concept. For example, both of the solution equations 766B-C may correspond to a mistake made with respect to order of operations, thereby indicating a possible challenge concept of the concept.

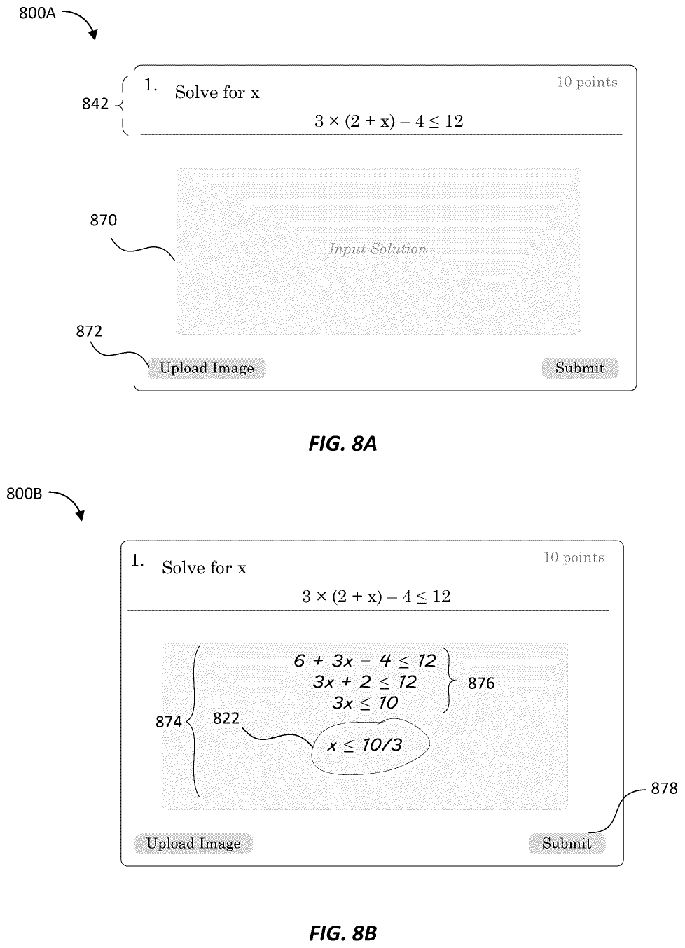

As noted above, the math problem 500A is in a multiple-choice format. In some cases, the math problem may be in a freeform format. Referring now to FIGS. 8A-B, a freeform math problem is provided, according to an embodiment herein. FIG. 8A provides a freeform math problem 800A and a freeform math problem solution 800B. Similar to the math problem 500A, the math problem 800A includes a problem statement 842. However, instead of being provided with answers 544 to select from, a user is provided with an answer field 870. To provide an answer, the student can type or write (e.g., via a pen or stylus) an answer into the answer field 870 or the student can upload an image (e.g., of a handwritten solution) by selection option 872. For example, a solution 874 provided as the freeform math problem solution 800B, may be an image uploaded by the student's client device. In other words, if the student solves the problem statement 842 with pen and paper, the student may use a client device, such as the client device 330 to capture an image of the paper with the answer on it.

The solution 874 may also be typed or written in by the student. The solution 874 may include an answer 822, and in some cases, solution work 876 showing the steps that were taken to solve the math problem. Once the solution 874 is provided, the student may select an option 878 to submit the answer 822. In some cases, just the answer 822 may be submitted while in others the entirety of the solution 874 may be submitted. The solution 874 and/or the answer 822 may be checked by the math engine 310 (e.g., by the problem checker 324).

The answer 822 submitted by the user may be analyzed by the math engine, in particular the problem checker of the math engine, to determine whether it corresponds to the correct answer or one of the distraction answers. In the cases where the answer 822 is submitted as an image, the math engine may use the content generator or other component to first convert the image into text. For example, the content generator may include an image-to-text content generator that identifies text within the submitted image. The identified text is determined to be the answer 822. In some cases, a similar technique may be used to identify the answer 822 from text either typed or written into the answer field 870.

Once the answer 822 is identified, the math engine may compare the freeform answer 822 to the correct answer and the distraction answers. By comparing the freeform answer 822 to the answers, the math engine determines whether the answer 822 is a correct answer or if it corresponds to a distraction answer. As can be appreciated, when the math problem is a freeform math problem, then the answer 822 provided by the student may be in a variety of different formats. For example, the answer 822 may be provided as a fraction (e.g., 10/3) or may as a decimal (e.g., 3.33), both of which are correct answers. To accommodate the variety of formats that a correct answer may be provided, a freeform answer template may be used to accommodate a range of correct answers.

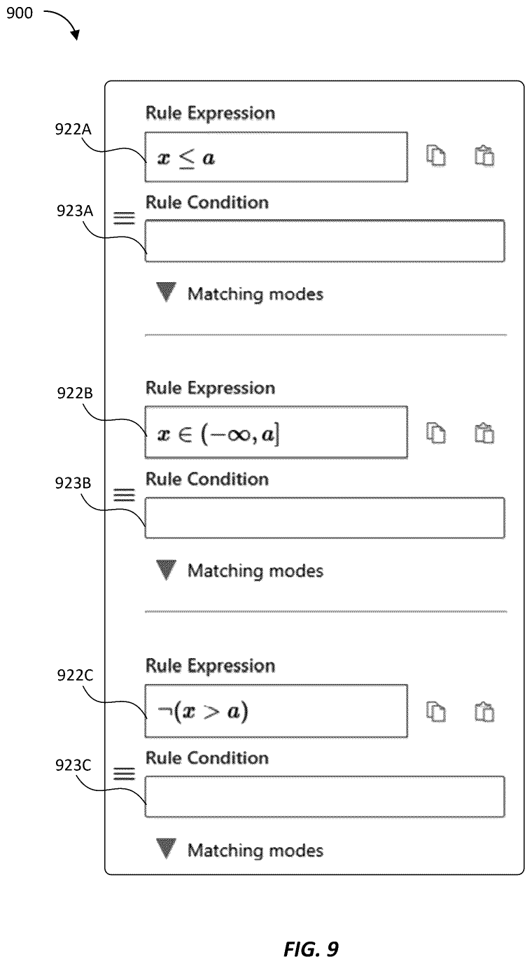

Referring now to FIG. 9, a freeform answer template 900 is provided. The freeform answer template 900 includes rule expression templates 922A-C that provide generic formats for acceptable correct answers. In the illustrated example, the correct answer may be that x is greater than or equal to a value ‘a’. As such, rule expression templates 922A-C illustrate various formats that a correct answer solving x as being greater than or equal to ‘a’ may be in. In some cases, a rule condition 923A-C may also be provided for a respective rule expression template 922A-C. For example, a rule condition may be that ‘a’ is an integer or a real number.

It should be appreciated that a similar freeform answer template may be used to generate one or more distraction answers. The same way that a correct answer may be provided in a variety of formats, so too may an incorrect answer. To accommodate the variety of forms that an incorrect answer may be provided in, the math engine may first generate one or more distraction answers using the answer template 700 and then generate one or more freeform distraction answers based on a respective distraction answer using the free form answer template 900. In other embodiments, an answer template may be a combination of the answer templates 700 and 900 such that distraction answers each having a variety of formats are generated.

Turning now to FIGS. 10-12, various user interfaces are provided in an education-based scenario to demonstrate various facets of the math engine, and its related functions, as disclosed herein. It should be appreciated, however, that although the following discussion relates to an education-based scenario that the concepts apply as well to other settings, situations, and scenarios.

Beginning with FIG. 10, FIG. 10 illustrates a GUI 1000 for providing a math engine, according to an embodiment herein. Specifically, the GUI 1000 illustrates a user interface 1041 that a reviewing user, such as an educator, may interact with. For example, the GUI 1000 may illustrate an example user interface 1411, as referenced in FIG. 1, provided to user C via the client device 140.

The user interface 1041 includes components associated with a math application (e.g., the math application 221 in FIG. 2), including components 1051, 1053, 1055, and 1057. The component 1051 is representative of a main title bar that allows a reviewing user to, among other functions, open, close, minimize, or maximize user interface 1041. The component 1051 includes a search box 1053 via which a user may input search queries with respect to content in the math application such as assignments, class lists, and class materials.

The component 1055 is representative of a feature bar that includes various icons for accessing modules of the application. For instance, the component 1055 includes an activity icon for checking alerts or reminders, a chat icon for chatting with other users, an icon for accessing team-oriented flows, an assignments icon for posting and reviewing assignments, a calendar icon for accessing a calendar feature, a call icon for placing voice calls, a files icon for managing files, and a store icon for accessing an app store. In some implementations, the component 1055 may include an icon for accessing a math engine, a math engine add-in application, or the like.

The app store-accessible via the store icon-provides the user with the ability to download and install “add-in” applications that are integrated into the context of the main application. Here, it is assumed for exemplary purposes that the user has installed a math engine through the store (or by another mechanism) or that the math application includes the math engine otherwise installed therein. As illustrated in FIG. 1000, the math engine can be loaded and executed in the context of another application, such as the math application 221 described with respect to FIG. 2.

In the illustrated example, an educator may navigate to an assignment summary 1043. The assignment summary 1043 may include a progress summary 1080 for a respective student, here Clara Martin. The progress summary 1080 is generated by a math engine, such as the math engine 110 or 310. The progress summary 1080 may indicate progress that the student has made with respect to various math concepts 1082A-C. As shown, each of the math concepts 1082A-C may be monitored for each assignment 1-9 that is completed by the student. Monitoring may include recording a number of correct answers that are selected. For each of the concepts 1082A-C, a grade or percentage of correct answers may be provided per assignment. As the student completes more assignments, the math engine records how well the student is doing with each concept and generates a summary of that progress. As can be appreciated, the process summary 1080 may provide vital information to the educator on how well a student is progressing or what concepts need to be revisited to aid the student.

The progress summary 1080 may include a submitted assignment icon 1084. Upon selection of the icon 1084, the educator may be provided with the respective submitted assignment. Turning now to FIG. 11, a GUI 1100 is provided illustrating a submitted assignment view, according to an embodiment herein. The GUI 1100 includes a user interface 1141, which may be the same or similar to the user interface 141 that is provided to a reviewing user (e.g., educator) via a client device. The user interface 141 may include an assignment summary 1143. The assignment summary 1143 can include various metrics for a given assignment, such as a grade for one or more math concepts present in the math assignment. Here, a metric 1186A is provided indicating how well the student did on math problems focused on order of operations, a metric 1186B is provided indicating how well the student did on math problems focused on inequalities, and a metric 1186C on how well the student did on math problems focused on factoring. It should be appreciated that other metrics may be provided as well, such as, for example, an improvement metric on how much the student has improved on a concept since a previous assignment.

The GUI 1100 also provides a correct answer panel 1188 and an incorrect answer panel 1190. The correct answer panel 1188 may include math problems that the student answered correctly. The incorrect answer panel 1190 may include math problems that the student answered incorrectly. The incorrectly answered problems provided by the incorrect answer panel 1190 may include the incorrect answer selected. In some cases, the incorrect answer panel 1190 may also include a rationale request 1134 that the student was prompted with after providing an incorrect answer. A rationale response 1136 is also provided. As can be appreciated, by providing the rationale response 1136, the educator can glean more information on why the student got the math problem wrong. In some cases, a feedback option 1191 is provided through which the educator can respond to the student's rationale response 1136. For example, if the student indicates that a solution step was incorrectly performed, the educator can respond to provide the correct solution step via the feedback option 1191.

It can be appreciated that it may be useful for the educator to compare the student's statistics to other students or the student's history. For example, by comparing this student's metrics on various concepts to other students, the educator can appreciate whether others are struggling with a particular concept as well. As such, one or more of the metrics 1186A-C may include a compare option 1192. Upon selection of the compare option 1192, the currently viewed student's metrics 1186A-C may be compared to other students.

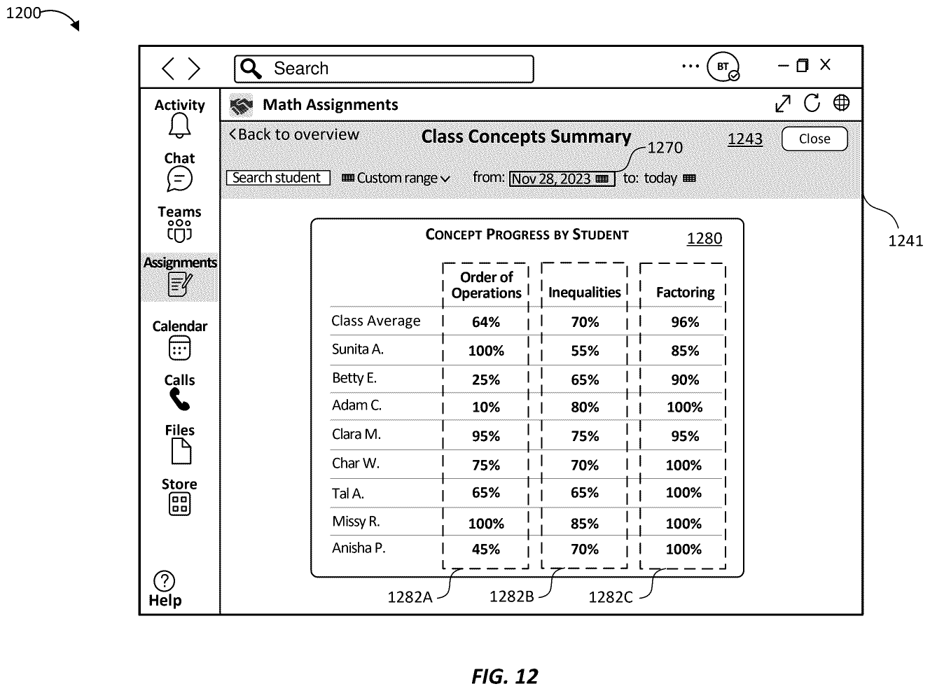

Referring now to FIG. 12, a GUI 1200 is provided illustrating concept progress by student within a class, according to an embodiment herein. The GUI 1200 may be provided to a reviewing user, such as an educator, by an interface 1241. The interface 1241 may include a class concepts summary 1243. The class concept summary 1243 may include a concept progress by student summary 1280 that provides metrics on various math concepts 1282A-C for students within a class. From the class concepts summary 1243, the educator may select a date range 1270 to evaluate the progress of various concepts for students within a class. Although not illustrated, in some cases, the educator may select which concepts to evaluate within the concept progress by student summary 1280.

As illustrated, the concept progress by student summary 1280 provides metrics for each student within a class and a class average for three math concepts: 1282A-C. A concept metric for a given student may be the average or median grade for the student on that concept as received by assignments completed within the selected date range 1270. From the concept progress by student summary 1280, the educator can appreciate which concepts to focus future lessons on and what concepts the students understand.

Referring to FIG. 13, FIG. 13 illustrates a computing system 1301 that may be used for providing a math engine and related functions, as described herein. For example, the client device 120 or 130 may be or include the computing system 1301. As illustrated, the computing system 1301 includes a processing system 1302 that includes a microprocessor and other circuitry that retrieves and executes software 1305 from storage system 1303. The processing system 1302 may be implemented within a single processing device but may also be distributed across multiple processing devices or sub-systems that cooperate in executing program instructions. Examples of the processing system 1302 include general purpose central processing units, graphical processing units, application specific processors, and logic devices, as well as any other type of processing device, combinations, or variations thereof.

The storage system 1303 may comprise any computer readable storage media readable by processing system 1302 and capable of storing software 1305. The storage system 1303 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 1303 may also include computer readable communication media over which at least some of the software 1305 may be communicated internally or externally. The storage system 1303 may be implemented as a single storage device but may also be implemented across multiple storage devices or sub-systems co-located or distributed relative to each other. The storage system 1303 may comprise additional elements, such as a controller capable of communicating with the processing system 1302 or possibly other systems.

The software 1305 (including math engine process 1306) may be implemented in program instructions and among other functions may, when executed by the processing system 1302, direct the processing system 1302 to operate as described with respect to the various operational scenarios, sequences, and processes illustrated herein. For example, the software 1305 may include program instructions for implementing a math engine and related functions, as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 1305 may include additional processes, programs, or components, such as operating system software, virtualization software, or other application software. The software 1305 may also comprise firmware or some other form of machine-readable processing instructions executable by the processing system 1302.

In general, the software 1305 may, when loaded into the processing system 1302 and executed, transform a suitable apparatus, system, or device (of which computing system 1301 is representative) overall from a general-purpose computing system into a special-purpose computing system customized to support insights features, functionality, and user experiences. Indeed, encoding the software 1305 on the storage system 1303 may transform the physical structure of the storage system 1303. The specific transformation of the physical structure may depend on various factors in different implementations of this description. Examples of such factors may include, but are not limited to, the technology used to implement the storage media of the storage system 1303 and whether the computer-storage media are characterized as primary or secondary storage, as well as other factors.

For example, if the computer readable storage media are implemented as semiconductor-based memory, the software 1305 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1307 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing system 1301 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

Examples are described herein in the context of systems and methods for providing a math engine and related functions. Those of ordinary skill in the art will realize that the foregoing description is illustrative only and is not intended to be in any way limiting. Reference is made in detail to implementations of examples as illustrated in the accompanying drawings. The same reference indicators will be used throughout the drawings and the following description to refer to the same or like items.

Additionally, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure. In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a system comprising: one or more computer readable storage media; one or more processors operatively coupled with the one or more computer readable storage media; and an application comprising program instructions stored on the one or more computer readable storage media that, when executed by the one or more processors, direct a computing system to at least: receive, from a first client device, an indication to start a math problem; provide, by a math engine, the math problem to the first client device, wherein the math problem comprises a problem statement; generate, by the math engine, a plurality of answers based on the problem statement, wherein: the plurality of answers comprises a correct answer and one or more distraction answers; and each of the one or more distraction answers corresponds to a respective challenge concept; receive, from a first client device, an answer for the math problem; determine, by the math engine, that the answer corresponds to a respective distraction answer of the one or more distraction answers; identify, by the math engine, a challenge concept based on the answer corresponding to the respective distraction answer; and generate, by the math engine, a second math problem based on the challenge concept for the first client device.

Example 2 is the system of any previous or subsequent Example, wherein the program instructions to provide, by the math engine, the math problem to the first client device cause, when executed by the one or more processors, to further direct the computing system to: identify, by the math engine, a math problem template based on the first client device; generate, by the math engine, the math problem comprising the problem statement based on the math problem template; and generate, by the math engine, the plurality of answers for the problem statement based on the math problem template.

Example 3 is the system of any previous or subsequent Example, wherein the program instructions to identify, by the math engine, the challenge concept based on the answer corresponding to the respective distraction answer cause, when executed by the one or more processors, to further direct the computing system to: receive, from the first client device, a plurality of answers responsive to a plurality of respective math problems; determine, by the math engine, a pattern based on each of the plurality of answers received responsive to the plurality of respective math problems corresponding to a respective distraction answer; and determine, by the math engine, that the pattern of each respective distraction answer is associated with the challenge concept.

Example 4 is the system of any previous or subsequent Example, wherein the program instructions further direct the computing system to: provide, by the math engine, a prompt identifying that the distraction answer was selected instead of the correct answer responsive to determining that the answer corresponds to the respective distraction answer; and request, by the math engine, input from the first client device on rationale for selection of the answer.

Example 5 is the system of any previous or subsequent Example, wherein the program instructions to receive, by the math engine, the answer for the math problem cause the, when executed by the one or more processors, to further direct the computing system to receive, by the math engine, the answer in a freeform format from the first client device, wherein the freeform format of the answer comprises one of the following: a typed answer input into an answer field by the first client device; or an image captured by the first client device.

Example 6 is the system of any previous or subsequent Example, wherein the math problem is part of a math assignment comprising a plurality of math problems, and the program instructions further direct the computing system to: grade, by the math engine, the math assignment based on answers received from the first client device; and generate by the math engine, a grade for the math assignment for the first client device, wherein the grade comprises an indication of a number of correct answers for the math assignment and one or more challenge concepts identified by the math assignment.

Example 7 is a method comprising: receiving, from a first client device, an indication to start a math problem; providing, by a math engine, the math problem to the first client device, wherein the math problem comprises a problem statement; generating, by the math engine, a plurality of answers based on the problem statement, wherein: the plurality of answers comprises a correct answer and one or more distraction answers; and each of the one or more distraction answers corresponds to a respective challenge concept; receiving, from a first client device, an answer for the math problem; determining, by the math engine, that the answer corresponds to a respective distraction answer of the one or more distraction answers; identifying, by the math engine, a challenge concept based on the answer corresponding to the respective distraction answer; and generating, by the math engine, a second math problem based on the challenge concept for the first client device.

Example 8 is the method of any previous or subsequent Example, wherein generating, by the math engine, the plurality of answers based on the problem statement further comprises: determining, by the math engine, an answer template corresponding to the problem statement; and generating, by a content generator of the math engine, the plurality of answers based on the answer template.

Example 9 is the method of any previous or subsequent Example, wherein providing, by the math engine, the math problem to the first client device further comprises: identifying, by the math engine, a math problem template based on the first client device; generating, by the math engine, the math problem comprising the problem statement based on the math problem template; identifying, by the math engine, an answer template corresponding to the math problem template; and generating, by the math engine, the plurality of answers for the problem statement based on the answer template.

Example 10 is the method of any previous or subsequent aspect, the method further comprising: providing, by the math engine, the plurality of answers for the math problem to the first client device in a multiple-choice format; and receiving, from the first client device the answer for the math problem comprises receiving, by the math engine, a selection of the answer from the plurality of answers in the multiple-choice format from the first client device.

Aspect 11 is the method of any previous or subsequent aspect, wherein receiving, from the first client device the answer for the math problem further comprises: receiving, from the first client device, a freeform answer to the problem statement; comparing, by the math engine, the freeform answer to the plurality of answers; and determining, by the math engine, a corresponding answer of the plurality of answers for the freeform answer.

Example 12 is the method of any previous or subsequent Example, wherein receiving, from the first client device the answer to the math problem further comprises: receiving an image from the first client device; performing, by the math engine, an image-to-text process to determine a freeform answer from the image; comparing, by the math engine, the freeform answer to the plurality of answers; and determining, by the math engine, a corresponding answer of the plurality of answers for the freeform answer.

Example 13 is the method of any previous or subsequent Example, the method further comprising: receiving, from a second client device, a second indication to start the math problem; providing, by the math engine, the math problem to the second client device; and generating, by the math engine, a second plurality of answers for the math problem based on the problem statement and the second client device, wherein the second plurality of answers is different than the plurality of answers for the first client device.

Example 14 is a computer readable storage media comprising processor-executable instructions configured to cause one or more processors to: receive, from a first client device, an indication to start a math problem; provide, by a math engine, the math problem to the first client device, wherein the math problem comprises a problem statement; generate, by the math engine, a plurality of answers based on the problem statement, wherein: the plurality of answers comprises a correct answer and one or more distraction answers; and each of the one or more distraction answers corresponds to a respective challenge concept; receive, from a first client device, an answer for the math problem; determine, by the math engine, that the answer corresponds to a respective distraction answer of the one or more distraction answers; identify, by the math engine, a challenge concept based on the answer corresponding to the respective distraction answer; and generate, by the math engine, a second math problem based on the challenge concept for the first client device.

Example 15 is the computer readable storage media of any previous or subsequent Example, wherein the processor-executable instructions to generate, by the math engine, the plurality of answers based on the problem statement cause the processor to further execute processor-executable instructions stored in the computer readable storage media to: identify, by the math engine, an answer template based on the first client device; and generate, by a content generator of the math engine, the plurality of answers for the problem statement based on the answer template.

Example 16 is the computer readable storage media of any previous or subsequent Example, wherein the processor-executable instructions cause the processor to further execute processor-executable instructions stored in the computer readable storage media to: determine, by the math engine, challenges associated with the first client device responsive to receiving the indication to start the math problem from the first client device; and determine, by the math engine, the math problem for the first client device based on the challenges associated with the first client device.

Example 17 is the computer readable storage media of any previous or subsequent Example, wherein the processor-executable instructions to receive, from the first client device, the answer for the math problem cause the processor to further execute processor-executable instructions stored in the computer readable storage media to: receive an image from the first client device; determine, by the math engine, a freeform answer to the math problem from the image; and match, by the math engine, the freeform answer to at least one of the plurality of answers, wherein the match allows for non-exact answer formats.

Example 18 is the computer readable storage media of any previous or subsequent Example, wherein the processor-executable instructions cause the processor to further execute processor-executable instructions stored in the computer readable storage media to: generate, by the math engine, an assignment summary for the first client device, wherein the assignment summary comprises one or more interactions between the first client device and the math engine; and provide, by the math engine, a display of the assignment summary.

Example 19 is the computer readable storage media of any previous or subsequent Example, wherein the processor-executable instructions cause the processor to further execute processor-executable instructions stored in the computer readable storage media to: receive, by the math engine, a request to generate a math problem template from a second client device; provide, by the math engine, a math problem template shell to the second client device; receive, by the math engine, one or more inputs into the math problem template shell from the second client device; and generate, by the math engine, the math problem template based on inputs into the math problem template shell, wherein: the math problem template comprises a generic problem statement and a plurality of generic answers; the plurality of generic answers comprises a generic correct answer and one or more generic distraction answers; and each of the generic distraction answers corresponds to a respective challenge concept.

Example 20 is the computer readable storage media of any previous or subsequent Example, wherein: the processor-executable instructions to generate, by the math engine, the second math problem based on the challenge concept for the first client device cause the processor to further execute processor-executable instructions stored in the computer readable storage media to: generating, by the math engine, a second problem statement; and generating, by the math engine, a second plurality of answers comprising at least one distraction answer corresponding to the challenge concept; and the processor-executable instructions cause the processor to further execute processor-executable instructions stored in the computer readable storage media to: provide, by the math engine, the second math problem to the first client device; receive, by the math engine, a second answer to the second math problem from the first client device; and compare, by the math engine, the second answer to the second plurality of answers.

What is claimed is:

1. A system comprising:
one or more computer readable storage media;
one or more processors operatively coupled with the one or more computer readable storage media; and
an application comprising program instructions stored on the one or more computer readable storage media that, when executed by the one or more processors, direct a computing system to at least:
receive, from a first client device, an indication to start a math problem;
provide, by a math engine, the math problem to the first client device, wherein the math problem comprises a problem statement;
generate, by the math engine, a plurality of answers based on the problem statement, wherein:
the plurality of answers comprises a correct answer and one or more distraction answers; and
each of the one or more distraction answers corresponds to a respective challenge concept;
receive, from a first client device, an answer for the math problem;
determine, by the math engine, that the answer corresponds to a respective distraction answer of the one or more distraction answers;
identify, by the math engine, a challenge concept based on the answer corresponding to the respective distraction answer; and
generate, by the math engine, a second math problem based on the challenge concept for the first client device.

2. The system of claim 1, wherein the program instructions to provide, by the math engine, the math problem to the first client device cause, when executed by the one or more processors, to further direct the computing system to:
identify, by the math engine, a math problem template based on the first client device;
generate, by the math engine, the math problem comprising the problem statement based on the math problem template; and
generate, by the math engine, the plurality of answers for the problem statement based on the math problem template.

3. The system of claim 1, wherein the program instructions to identify, by the math engine, the challenge concept based on the answer corresponding to the respective distraction answer cause, when executed by the one or more processors, to further direct the computing system to:
receive, from the first client device, a plurality of answers responsive to a plurality of respective math problems;
determine, by the math engine, a pattern based on each of the plurality of answers received responsive to the plurality of respective math problems corresponding to a respective distraction answer; and
determine, by the math engine, that the pattern of each respective distraction answer is associated with the challenge concept.

4. The system of claim 1, wherein the program instructions further direct the computing system to:
provide, by the math engine, a prompt identifying that the distraction answer was selected instead of the correct answer responsive to determining that the answer corresponds to the respective distraction answer; and
request, by the math engine, input from the first client device on rationale for selection of the answer.

5. The system of claim 1, wherein the program instructions to receive, by the math engine, the answer for the math problem cause the, when executed by the one or more processors, to further direct the computing system to receive, by the math engine, the answer in a freeform format from the first client device, wherein the freeform format of the answer comprises one of the following:
a typed answer input into an answer field by the first client device; or
an image captured by the first client device.

6. The system of claim 1, wherein the math problem is part of a math assignment comprising a plurality of math problems, and the program instructions further direct the computing system to:
grade, by the math engine, the math assignment based on answers received from the first client device; and
generate by the math engine, a grade for the math assignment for the first client device, wherein the grade comprises an indication of a number of correct answers for the math assignment and one or more challenge concepts identified by the math assignment.

7. A method comprising:
receiving, from a first client device, an indication to start a math problem;
providing, by a math engine, the math problem to the first client device, wherein the math problem comprises a problem statement;
generating, by the math engine, a plurality of answers based on the problem statement, wherein:
the plurality of answers comprises a correct answer and one or more distraction answers; and
each of the one or more distraction answers corresponds to a respective challenge concept;
receiving, from a first client device, an answer for the math problem;
determining, by the math engine, that the answer corresponds to a respective distraction answer of the one or more distraction answers;
identifying, by the math engine, a challenge concept based on the answer corresponding to the respective distraction answer; and
generating, by the math engine, a second math problem based on the challenge concept for the first client device.

8. The method of claim 7, wherein generating, by the math engine, the plurality of answers based on the problem statement further comprises:
determining, by the math engine, an answer template corresponding to the problem statement; and
generating, by a content generator of the math engine, the plurality of answers based on the answer template.

9. The method of claim 7, wherein providing, by the math engine, the math problem to the first client device further comprises:
identifying, by the math engine, a math problem template based on the first client device;
generating, by the math engine, the math problem comprising the problem statement based on the math problem template;
identifying, by the math engine, an answer template corresponding to the math problem template; and
generating, by the math engine, the plurality of answers for the problem statement based on the answer template.

10. The method of claim 7, the method further comprising:
providing, by the math engine, the plurality of answers for the math problem to the first client device in a multiple-choice format; and
receiving, from the first client device the answer for the math problem comprises receiving, by the math engine, a selection of the answer from the plurality of answers in the multiple-choice format from the first client device.

11. The method of claim 7, wherein receiving, from the first client device the answer for the math problem further comprises:
receiving, from the first client device, a freeform answer to the problem statement;
comparing, by the math engine, the freeform answer to the plurality of answers; and
determining, by the math engine, a corresponding answer of the plurality of answers for the freeform answer.

12. The method of claim 7, wherein receiving, from the first client device the answer to the math problem further comprises:
receiving an image from the first client device;
performing, by the math engine, an image-to-text process to determine a freeform answer from the image;
comparing, by the math engine, the freeform answer to the plurality of answers; and
determining, by the math engine, a corresponding answer of the plurality of answers for the freeform answer.

13. The method of claim 7, the method further comprising:
receiving, from a second client device, a second indication to start the math problem;
providing, by the math engine, the math problem to the second client device; and
generating, by the math engine, a second plurality of answers for the math problem based on the problem statement and the second client device, wherein the second plurality of answers is different than the plurality of answers for the first client device.

14. A computer readable storage media comprising processor-executable instructions configured to cause one or more processors to:
receive, from a first client device, an indication to start a math problem;
provide, by a math engine, the math problem to the first client device, wherein the math problem comprises a problem statement;
generate, by the math engine, a plurality of answers based on the problem statement, wherein:
the plurality of answers comprises a correct answer and one or more distraction answers; and
each of the one or more distraction answers corresponds to a respective challenge concept;
receive, from a first client device, an answer for the math problem;
determine, by the math engine, that the answer corresponds to a respective distraction answer of the one or more distraction answers;
identify, by the math engine, a challenge concept based on the answer corresponding to the respective distraction answer; and
generate, by the math engine, a second math problem based on the challenge concept for the first client device.

15. The computer readable storage media of claim 14, wherein the processor-executable instructions to generate, by the math engine, the plurality of answers based on the problem statement cause the processor to further execute processor-executable instructions stored in the computer readable storage media to:
identify, by the math engine, an answer template based on the first client device; and
generate, by a content generator of the math engine, the plurality of answers for the problem statement based on the answer template.

16. The computer readable storage media of claim 14, wherein the processor-executable instructions cause the processor to further execute processor-executable instructions stored in the computer readable storage media to:
determine, by the math engine, challenges associated with the first client device responsive to receiving the indication to start the math problem from the first client device; and
determine, by the math engine, the math problem for the first client device based on the challenges associated with the first client device.

17. The computer readable storage media of claim 14, wherein the processor-executable instructions to receive, from the first client device, the answer for the math problem cause the processor to further execute processor-executable instructions stored in the computer readable storage media to:
receive an image from the first client device;
determine, by the math engine, a freeform answer to the math problem from the image; and
match, by the math engine, the freeform answer to at least one of the plurality of answers, wherein the match allows for non-exact answer formats.

18. The computer readable storage media of claim 14, wherein the processor-executable instructions cause the processor to further execute processor-executable instructions stored in the computer readable storage media to:
generate, by the math engine, an assignment summary for the first client device, wherein the assignment summary comprises one or more interactions between the first client device and the math engine; and
provide, by the math engine, a display of the assignment summary.

19. The computer readable storage media of claim 14, wherein the processor-executable instructions cause the processor to further execute processor-executable instructions stored in the computer readable storage media to:
receive, by the math engine, a request to generate a math problem template from a second client device;
provide, by the math engine, a math problem template shell to the second client device;
receive, by the math engine, one or more inputs into the math problem template shell from the second client device; and
generate, by the math engine, the math problem template based on inputs into the math problem template shell, wherein:
the math problem template comprises a generic problem statement and a plurality of generic answers;
the plurality of generic answers comprises a generic correct answer and one or more generic distraction answers; and
each of the generic distraction answers corresponds to a respective challenge concept.

20. The computer readable storage media of claim 14, wherein:
the processor-executable instructions to generate, by the math engine, the second math problem based on the challenge concept for the first client device cause the processor to further execute processor-executable instructions stored in the computer readable storage media to:
generating, by the math engine, a second problem statement; and
generating, by the math engine, a second plurality of answers comprising at least one distraction answer corresponding to the challenge concept; and
the processor-executable instructions cause the processor to further execute processor-executable instructions stored in the computer readable storage media to:
provide, by the math engine, the second math problem to the first client device;
receive, by the math engine, a second answer to the second math problem from the first client device; and
compare, by the math engine, the second answer to the second plurality of answers.
